(19) United States
(12) Patent Application Publication
(10) Pub. No.: US 2008/0242276 A1
(43) Pub. Date: Oct. 2, 2008

(54) Method for Saving Communication Fee by Wireless Communication Interface of Mobile Phones

(76) Inventor: Chi-Hao Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/057,380

(22) Filed: Mar. 28, 2008

(30) Foreign Application Priority Data
Mar. 30, 2007 (TW) 096111465

(51) Int. Cl. H04M 3/42

(52) U.S. Cl. 455/414.1

(57) ABSTRACT

A method for saving communication fee by a wireless communication interface of mobile communication devices includes forming a fee saving network by a plurality of mobile communication devices through the wireless communication interface, inputting a destination terminal number into a first mobile communication device of the plurality of mobile communication devices for establishing a connection with a destination terminal, determining a specific mobile communication device of the plurality of mobile communication devices to establish the connection with the destination terminal according to a determination principle, and outputting a dialing signal by the first mobile communication device to make the specific mobile communication device establish the connection with the destination terminal.

### BACKGROUND OF THE INVENTION

1. Field of the Invention

The present invention relates to a method for saving communication fees by a wireless communication Interface of mobile communication devices, and more particularly, to a method for forming a fee saving network by the wireless communication interface built in each of a plurality of mobile communication devices to provide a mobile communication device with the lowest communication rate for a user to select to establish a connection according to a determination principle.

2. Description of the Prior Art

With the popularity of mobile communications, there are many telecommunication companies providing communication services. Since communication services provided by different telecommunication companies have different discount programs, it is common that a user carries several mobile phones in order to select a most beneficial communication service when establishing a connection. Taking on-net calls for example, when a user would like to establish a connection (ex. making a phone call or connecting to the Internet) with a destination terminal number belonging to a telecommunication company A, it will be cheaper for the user to dial with a mobile phone having a number also belonging to the telecommunication company A; and when establishing a connection with an another destination terminal number belonging to a telecommunication company B, then using a mobile phone having a number belonging to the telecommunication company B will be cheaper. Therefore, before establishing connections, the user has to manually check that the number being connected belongs to which telecommunication company, such that a most appropriate mobile phone can then be selected for saving communication fees.

In addition, each telecommunication company further provides other discount programs, such as providing a different discount when making a call during a different time period. For example, the telecommunication company A may provide a most beneficial communication rate for establishing a connection in the early morning, but the telecommunication company B provides a most beneficial communication rate at night. Thus, the user not only needs to carry two mobile phones respectively capable of using communication services provided by the telecommunication companies A and B, but also needs to remember discount programs of the telecommunication companies, so as to properly select an appropriate communication service providing a most appropriate communication fee rate.

Therefore, when the number of mobile phones owned by the user increases, the way for saving communication fees through manually selecting an appropriate mobile phone to establish a connection causes more and more troubles for the user. Additionally, the discount programs provided by the telecommunication companies are getting complicated, and thus it is very inconvenient for the user to make a correct decision to select a most appropriate mobile phone for saving communication fees.

### SUMMARY OF THE INVENTION

It is therefore a primary objective of the present invention to provide a method for saving communication fee by a wireless communication interface of mobile phones.

The present invention discloses a method for saving communication fee by a wireless communication interface of a mobile communication device. The method includes forming a fee saving network by a plurality of mobile communication devices through the wireless communication interface; inputting a destination terminal number into a first mobile communication device of the plurality of mobile communication devices for establishing a connection with a destination terminal; determining a specific mobile communication device of the plurality of mobile communication devices to establish the connection with the destination terminal according to a determination principle; and outputting a dialing signal by the first mobile communication device to make the specific mobile communication device establish the connection with the destination terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process for saving communication fees by a wireless communication interface of a mobile communication device according to the present invention.

FIG. 2 is a schematic diagram of the fee saving network according to the present invention.

FIG. 3 is a schematic diagram of a process for forming the fee saving network according to an embodiment of the present invention.

FIG. 4 is a schematic diagram of a process of the low price first algorithm according to the present invention.

FIG. 5 is a schematic diagram of a process for the user to establish a connection with a destination terminal according to an embodiment of the present invention.

### DETAILED DESCRIPTION

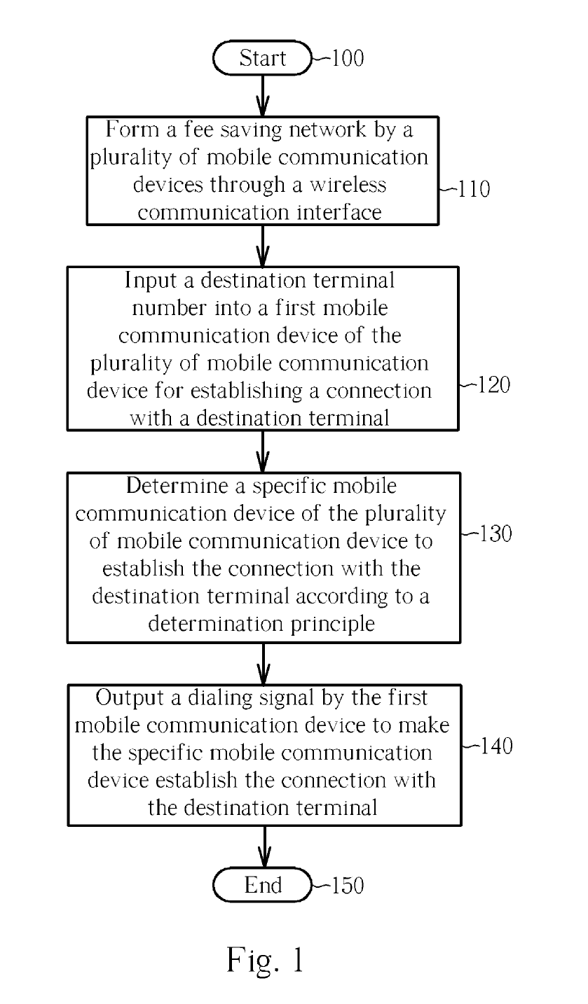

Please refer to FIG. 1. FIG. 1 is a schematic diagram of a process 10 for saving communication fees by a wireless communication interface of a mobile communication device according to the present invention. The process 10 includes the flowing steps:

Step 100: start.

Step 110: form a fee saving network by a plurality of mobile communication devices through a wireless communication interface.

Step 120: input a destination terminal number into a first mobile communication device of the plurality of mobile communication device for establishing a connection with a destination terminal.

Step 130: determine a specific mobile communication device of the plurality of mobile communication device to establish the connection with the destination terminal according to a determination principle.

Step 140: output a dialing signal by the first mobile communication device to make the specific mobile communication device establish the connection with the destination terminal.

Step 150: end.

Therefore, the present invention forms a fee saving network by the plurality of mobile communication devices through a built-in wireless communication interface. Preferable, the wireless communication interface can be a Bluetooth wireless interface. After the fee saving network is formed by the plurality of mobile communication devices through the wireless communication interface, the plurality of mobile communication devices can then exchange related information by the fee saving network based on the wireless communication interface. Next, when a first mobile communication device of the plurality of mobile communication devices is inputted a destination terminal number for establishing a connection with a destination terminal, the first mobile communication device can determine to select a specific mobile communication device having the lowest communication fee rate for establishing the connection with the destination terminal according to the related information exchanged by the fee saving network. After the first mobile communication device outputs a dialing signal to make the specific mobile communication device establish the connection with the destination terminal, the first mobile communication device can then exchange signals corresponding to the connection with the specific mobile communication device through the wireless communication interface. Besides, please note that the related information exchanged by the plurality of mobile communication devices through the fee saving network can include on-net communication rate information of a communication system corresponding to each of the plurality of mobile communication devices, off-net communication rate information of a communication system corresponding to each of the plurality of mobile communication devices when dialing other communication systems, communication records of a communication system corresponding to each of the plurality of mobile communication devices, monthly rental balances of a communication system corresponding to each of the plurality of mobile communication devices, and so on, and thus the mobile communication device with the lowest communication fee rate can be selected for the first mobile communication device to establish the connection.

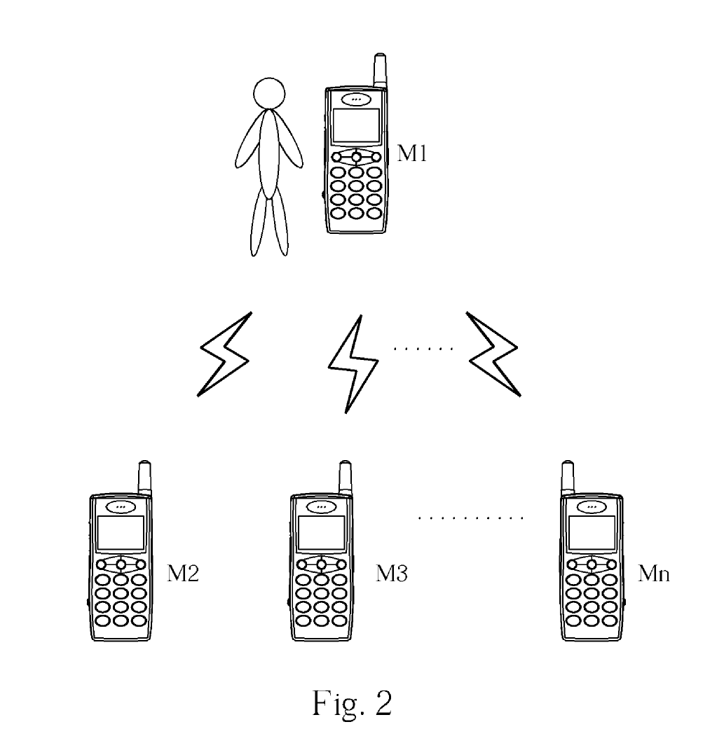

Please refer to FIG. 2. FIG. 2 is a schematic diagram of the fee saving network 20 according to the present invention. As shown in FIG. 2, the fee saving network 20 is composed of mobile communication devices M1-Mn through a built-in Bluetooth wireless communication interface. Since the Bluetooth interface is a standard built-in wireless communication interface of a mobile communication device, through the Bluetooth interface, the present invention can thus integrate the plurality of mobile communication devices to form the fee saving network for achieving an objective of saving communication fees.

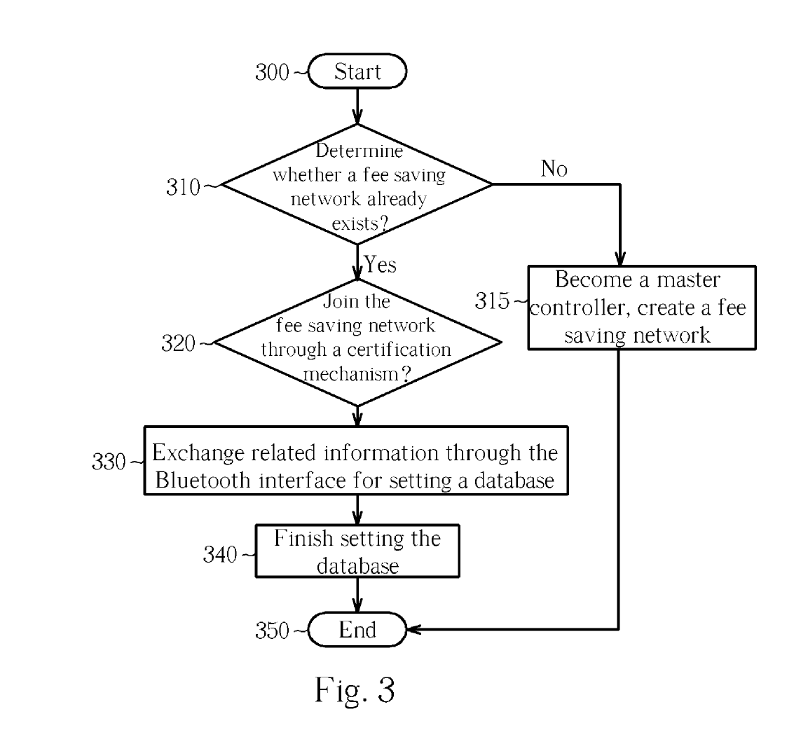

Please further refer to FIG. 3. FIG. 3 is a schematic diagram of a process 30 for forming the fee saving network according to an embodiment of the present invention. The process 30 is a process that a mobile communication device joins a fee saving network or creates a fee saving network, and includes the following steps:

Step 300: starts.

Step 310: determine whether a fee saving network already exists. If so, proceed to Step 320; and if not, proceed to Step 315.

Step 315: become a master controller, create a fee saving network, and proceed to Step 350.

Step 320: join the fee saving network through a certification mechanism.

Step 330: exchange related information through the Bluetooth interface for setting a database.

Step 340: finish setting the database.

Step 350: end.

Therefore, when a mobile communication device is initiated, the mobile communication device can automatically search whether a fee saving network has already existed in the communication range of the Bluetooth interface. If a fee saving network already exists in the communication range, the mobile communication device can join the fee saving network through a certification mechanism. If there dose not exist a fee saving network in the communication range, the mobile communication device can become a master controller, and can create a fee saving network waiting for other mobile communication devices joining in. Preferably, for preventing the mobile communication devices from being embezzled, the certification mechanism can be realized by setting a password, comparing international mobile equipment identities (IMEI) of the mobile communication devices, or comparing international mobile subscriber identities of subscriber identity module (SIM) cards. After the mobile communication device success fully joins the fee saving network, through the fee saving network, the mobile communication device can then exchange related information, such as communication fee rate, with each of the mobile communication devices in the fee saving network for setting or updating the database. After the database is finished setting or updating, the process 30 for forming the fee saving network is completed. Please note that the content of the database can includes on-net communication rate information of a communication system corresponding to each mobile communication device, off-net communication rate information of a communication system corresponding to each mobile communication devices when dialing other communication systems, communication records of a communication system corresponding to each mobile communication device and monthly rental balances of a communication system corresponding to each mobile communication device. Thus, through the communication records of each mobile communication device stored in the database, the present invention can figure out a communication fee rate of each mobile communication device dialing to a specific phone number; and through the monthly rental balances of each mobile communication device stored in the database, the present invention can notify the user to use a mobile communication device having the most monthly rental balances first.

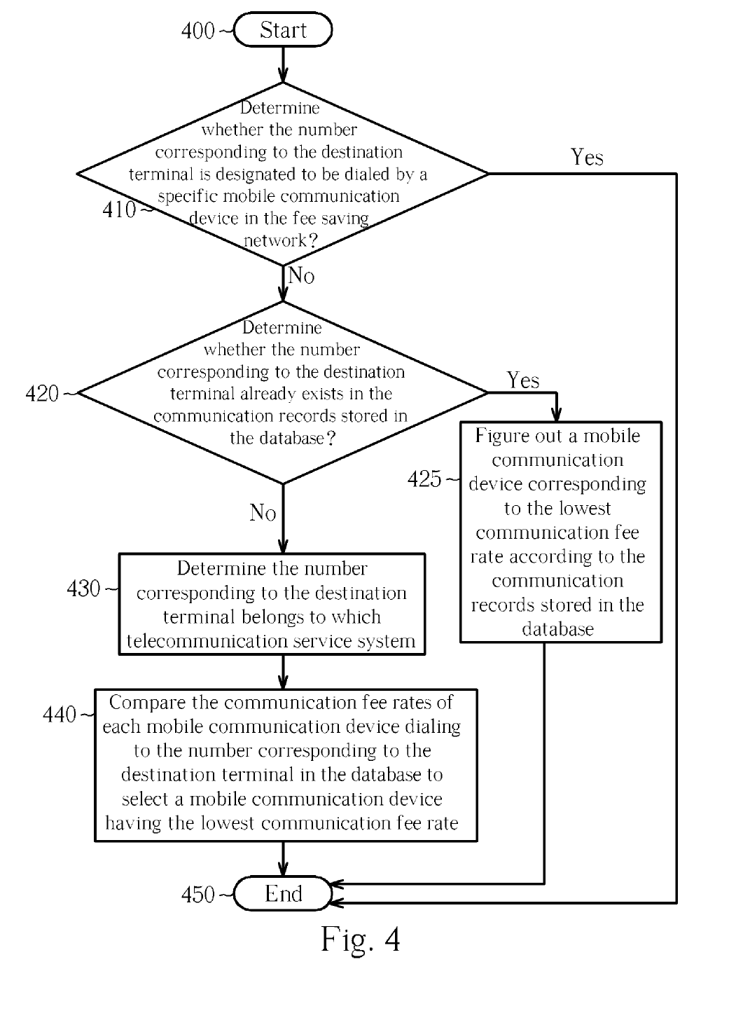

Then, when the user wants to establish a connection (ex. making a call) with a destination terminal through the fee saving network 20, by utilizing a low price first algorithm, the first mobile communication device hold by the user can thus determine to select a second mobile communication device having the lowest communication fee for establishing the connection with the destination terminal according to the content of the database. Please refer to FIG. 4. FIG. 4 is a schematic diagram of a process 40 of the low price first algorithm according to the present invention. The process 40 includes the following steps:

Step 400: start.

Step 410: determine whether the number corresponding to the destination terminal is designated to be dialed by a specific mobile communication device in the fee saving network. If so, proceed to Step 450; if not, proceed to Step 420.

Step 420: determine whether the number corresponding to the destination terminal already exists in the communication records stored in the database. If so, proceed to Step 425; if not, proceed to Step 430.

Step 425: figure out a mobile communication device corresponding to the lowest communication fee rate according to the communication records stored in the database, and proceed to Step 450.

Step 430: determine the number corresponding to the destination terminal belongs to which telecommunication service system.

Step 440: compare the communication fee rates of each mobile communication device dialing to the number corresponding to the destination terminal in the database to select a mobile communication device having the lowest communication fee rate.

Step 450: end.

According to the process 40, when the user wants to making a call, the process 40 of the present invention first determines whether the number corresponding to the destination terminal is designated to be dialed by a specific mobile communication device in the fee saving network. If it dose, the present invention ends the process 40; and if not, the present invention then determines whether the number corresponding to the destination terminal has already existed in the communication records stored in the database. When the number being dialed already exists in the communication records stored in the database, the present invention can figure out a mobile communication device corresponding to the lowest communication fee rate according to the communication records stored in the database, and ends the process 40. Conversely, when the number does not exist in the communication records stored in the database, the present invention then determines which telecommunication service system corresponds to the number, and compares the communication fee rates of each mobile communication device dialing to the number in the database to select a mobile communication device having the lowest communication fee rate. Please note that the low price first determination principle of the present invention is merely an embodiment of the present invention, so that appropriate modifications can certainly be made by those skilled in the art according to practical demands, and are still in the range of the present invention.

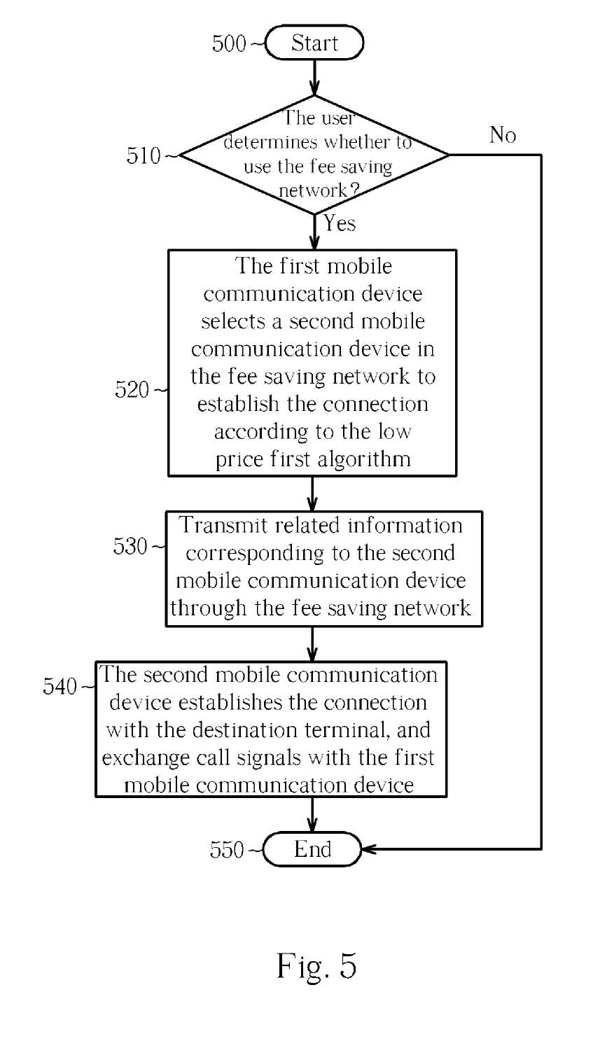

Please further refer to FIG. 5. FIG. 5 is a schematic diagram of a process 50 for the user to establish a connection with a destination terminal according to an embodiment of the present invention. The process 50 is used when the user utilize a first mobile communication device to establish a connection with a destination terminal, and includes the following steps:

Step 500: start.

Step 510: the user determines whether to use the fee saving network. If so, proceed to Step 520; and if not; proceed to Step 550.

Step 520: the first mobile communication device selects a second mobile communication device in the fee saving network to establish the connection according to the low price first algorithm.

Step 530: transmit related information corresponding to the second mobile communication device through the fee saving network.

Step 540: the second mobile communication device establishes the connection with the destination terminal, and exchange call signals with the first mobile communication device.

Step 550: ends.

According to the process 50 of the present invention, when the user wants to utilize the first mobile communication device to establish a connection (ex. Make a call) with a destination terminal, the user can determine whether to use the fee saving network of the present invention. When the user decides not to make a call through the fee saving network, the user can directly utilize the first mobile communication device to make the call, or even shut the fee saving network. On the other hand, when the user decides to use the fee saving network, the first mobile communication device can select the second mobile communication device in the fee saving network to make the call according to the low price first algorithm mentioned above. After the second mobile communication device dials, the present invention can exchange corresponding call signals (i.e. voice signal) with the first mobile communication device through the fee saving network based on the Bluetooth interface. Therefore, through the fee saving network, the present invention not only can achieve the objective for saving communication fees, but also can increase convenience when using mobile communication devices.

As mentioned above, the present invention forms a fee saving network by the plurality of mobile communication devices through a built-in wireless communication interface, and provides a mobile communication device having the lowest communication fee rate for the user to establish a connection according to a low price first determination principle. Therefore, the present invention not only can eliminate the inconvenience that the user has to rummage for a mobile communication device in order to save communication fees when making a call, but also can reduce the probability that the user could spend extra money due to taking a wrong mobile communication device.

Those skilled in the art will readily observe that numerous modifications and alterations of the device and method may be made while retaining the teachings of the invention.

What is claimed is:

1. A method for saving communication fee by a wireless communication interface of a mobile communication device comprising:
forming a fee saving network by a plurality of mobile communication devices through the wireless communication interface;
inputting a destination terminal number into a first mobile communication device of the plurality of mobile communication devices for establishing a connection with a destination terminal;
determining a specific mobile communication device of the plurality of mobile communication devices to establish the connection with the destination terminal according to a determination principle; and
outputting a dialing signal by the first mobile communication device to make the specific mobile communication device establish the connection with the destination terminal.

2. The method of claim 1, wherein the wireless communication interface is a Bluetooth interface.

3. The method of claim 1 further comprising:
the first mobile communication device obtaining a plurality of communication information of the plurality of mobile communication devices in the fee saving network through the wireless communication interface.

4. The method of claim 3, wherein the communication information comprises communication rate information of communication systems corresponding to each of the plurality of mobile communication devices.

5. The method of claim 3, wherein the communication information comprises communication records of communication systems corresponding to each of the plurality of mobile communication devices.

6. The method of claim 3, wherein the communication information comprises monthly rental balances of communication systems corresponding to each of the plurality of mobile communication devices.

7. The method of claim 1 further comprising: the plurality of mobile communication devices exchanging a plurality of communication information with each other through the wireless communication interface.

8. The method of claim 7, wherein the communication information comprises communication rate information of communication systems corresponding to each of the plurality of mobile communication devices.

9. The method of claim 7, wherein the communication information comprises off-net communication rate information of communication systems corresponding to each of the plurality of mobile communication devices when dialing other communication systems.

10. The method of claim 7, wherein the communication information comprises on-net communication rate information of communication systems corresponding to each of the plurality of mobile communication devices.

11. The method of claim 7, wherein the communication information comprises communication records of communication systems corresponding to each of the plurality of mobile communication devices.

12. The method of claim 3, wherein the communication information comprises monthly rental balances of communication systems corresponding to each of the plurality of mobile communication devices.

13. The method of claim 1, wherein determining the specific mobile communication device of the plurality of mobile communication devices to establish the connection with the destination terminal according to the determination principle comprises determining the specific mobile communication device of the plurality of mobile communication devices to establish the connection with the destination terminal according to a comparison result of communication rates of each of the plurality of mobile communication devices needed to establish the connection with the destination terminal.

14. The method of claim 1, wherein determining the specific mobile communication device of the plurality of mobile communication devices to establish the connection with the destination terminal according to the determination principle comprises determining the specific mobile communication device of the plurality of mobile communication devices to establish the connection with the destination terminal according to communication records of communication systems corresponding to each of the plurality of mobile communication devices.

15. The method of claim 1, wherein determining the specific mobile communication device of the plurality of mobile communication devices to establish the connection with the destination terminal according to the determination principle comprises determining the specific mobile communication device of the plurality of mobile communication devices to establish the connection with the destination terminal according to monthly rental balances of communication systems corresponding to each of the plurality of mobile communication devices.

16. The method of claim 1, wherein determining the specific mobile communication device of the plurality of mobile communication devices to establish the connection with the destination terminal according to the determination principle comprises determining the specific mobile communication device of the plurality of mobile communication devices to establish the connection with the destination terminal according to priority of each of the plurality of mobile communication devices corresponding to the destination terminal.

17. The method of claim 1 further comprising: turning off the fee saving network through a mobile communication device of the plurality of mobile communication devices.

18. The method of claim 1 further comprising: turning on the fee saving network through a mobile communication device of the plurality of mobile communication devices.

19. The method of claim 1 further comprising: the specific mobile communication device establishing the connection with the destination terminal according to the dialing signal comprising the destination terminal number and a connection instruction.
